(19) United States
(12) Patent Application Publication
(10) Pub. No.: US 2026/0311116 A1
(43) Pub. Date: Oct. 8, 2026

(54) STORAGE MANAGEMENT SYSTEM AND STORAGE MANAGEMENT METHOD

(71) Applicant: NEC Corporation, Tokyo (JP)

(72) Inventors: Yukikazu YAMAOKA, Tokyo (JP); Kei SATO, Tokyo (JP); Miku YANAGIMOTO, Tokyo (JP)

(73) Assignee: NEC Corporation, Tokyo (JP)

(21) Appl. No.: 19/461,899

(22) Filed: Jan. 28, 2026

(30) Foreign Application Priority Data
Mar. 21, 2025 (JP) 2025-046236

(51) Int. Cl. G06Q 10/087

(52) U.S. Cl. CPC G06Q 10/0872

(57) ABSTRACT

A storage management system according to the present disclosure includes an allocation unit that allocates, based on information regarding a storage object desired to be stored and information regarding a storage place, a space in which the storage object is storable from within the storage place, and a generation unit that generates a storage available period during which the storage object is storable in the space, based on current and future usage statuses of the space.

### INCORPORATION BY REFERENCE

This application is based upon and claims the benefit of priority from Japanese patent application No. 2025-046236, filed on Mar. 21, 2025, the disclosure of which is incorporated herein in its entirety by reference.

### TECHNICAL FIELD

The present disclosure relates to a storage management system, a storage management method, and a program.

### BACKGROUND ART

JP 2019-512115 A discloses a method for warehousing space planning for determining a storage space in which storage should be performed within a prescribed period by using current storage space usage information on a warehouse.

### SUMMARY

In the method for warehousing space planning disclosed in JP 2019-512115 A, a future usage status is not considered, and consideration is not given to a case where storage can be performed if a period is shifted. It is therefore difficult to say that the storage space (storage place) is effectively utilized.

In view of the above-described problem, an example object of the present disclosure is to provide a storage management system, a storage management method, and a program capable of effectively using a storage place.

A storage management system according to an example aspect of the present disclosure includes an allocation unit that allocates, based on information regarding a storage object desired to be stored and information regarding a storage place, a space in which the storage object is storable from within the storage place, and a generation unit that generates a storage available period during which the storage object is storable in the space, based on current and future usage statuses of the space.

A storage management system according to an example aspect of the present disclosure includes a reception unit that receives information regarding a storage object desired to be stored in a space of a storage place, and a generation unit that generates a storage available period during which the storage object is storable in the space, based on current and future usage statuses of the space.

A storage management method according to an example aspect of the present disclosure includes executing, by a computer, processing of allocating, based on information regarding a storage object desired to be stored and information regarding a storage place, a space in which the storage object is storable from within the storage place, and generating a storage available period during which the storage object is storable in the space, based on current and future usage statuses of the space.

A program according to an example aspect of the present disclosure causes a computer to execute processing of allocating, based on information regarding a storage object desired to be stored and information regarding a storage place, a space in which the storage object is storable from within the storage place, and generating a storage available period during which the storage object is storable in the space, based on current and future usage statuses of the space.

According to the present disclosure, it is possible to provide a storage management system, a storage management method, and a program capable of effectively using a storage place.

### BRIEF DESCRIPTION OF THE DRAWINGS

FIG. 1 is a block diagram illustrating a storage management system according to the present disclosure;

FIG. 2 is a flowchart illustrating a storage management method according to the present disclosure;

FIG. 3 is a block diagram illustrating a storage management system according to the present disclosure;

FIG. 4 is a display example of a terminal device;

FIG. 5 is a display example of the terminal device;

FIG. 6 is a display example of the terminal device;

FIG. 7 is a display example of the terminal device;

FIG. 8 is a block diagram illustrating a storage management system according to the present disclosure;

FIG. 9 is a flowchart illustrating an information processing method according to the present disclosure;

FIG. 10 is a block diagram illustrating a storage management system according to the present disclosure;

FIG. 11 is a display example of the terminal device;

FIG. 12 is a display example of the terminal device;

FIG. 13 is a display example of the terminal device;

FIG. 14 is a block diagram illustrating a server according to the present disclosure;

FIG. 15 is a flowchart illustrating an information processing method according to the present disclosure; and

FIG. 16 is a block diagram illustrating a configuration example of the terminal device, an information processing device, and the server according to the present disclosure.

### EXAMPLE EMBODIMENT

Hereinafter, the present disclosure will be described according to example embodiments, but the disclosure described in the claims is not limited to the following example embodiments. Not all of the configurations described in the example embodiments are essential as means for solving the problem. In the drawings, the same elements are denoted by the same reference numerals, and repeated description will be omitted as necessary.

### First Example Embodiment

### Storage Management System

Hereinafter, a configuration of a storage management system according to the present disclosure will be described with reference to FIG. 1. FIG. 1 is a block diagram illustrating the storage management system according to the present disclosure. As illustrated in FIG. 1, a storage management system 10 includes an allocation unit 11 and a generation unit 12.

### Allocation Unit

The allocation unit 11 allocates, based on information regarding a storage object desired to be stored and information regarding a storage place, a space in which the storage object can be stored from within the storage place. The information regarding the storage object includes information of the name, packing style, size, amount, weight, storage characteristics, customer (shipper), and storage period of the storage object.

The storage characteristics are, for example, characteristics regarding temperature, humidity, odor, vibration resistance, hygienic status, explosiveness, and danger at the time of storage. For example, in a case where the storage object is fish, it is necessary to secure a predetermined distance so as not to transmit odor to other storage objects. In addition, hygienic temperature control is required for storage of fish. In a case where the storage object is fish, the storage characteristics are therefore the odor, temperature, and hygienic status.

The information regarding the storage place includes, for example, the space (area or volume), temperature, humidity, hygienic status, atmospheric pressure, explosion-proof specification, load-bearing capacity, information regarding fire resistance, and name of the storage place.

The allocation unit 11 compares the information regarding the storage object with the information regarding the storage place, and allocates a space in which the storage object can be stored from within the storage place. For example, in a case where the storage object is fish, the allocation unit 11 allocates an appropriate space in which the odor, temperature, and hygienic status can be managed from within the storage place.

The allocation unit 11 allocates a space from the information regarding the storage object desired to be stored and the information regarding the storage place by using a predetermined rule. The allocation unit 11 may allocate a space by using a learning model. The learning model is a model obtained by learning of outputting the space in which the storage object can be stored with the information regarding the storage object desired to be stored and the information regarding the storage place as inputs. For example, the learning model is a model obtained by learning of allocation results in the past. That is, the allocation unit 11 may be configured to allocate a space by using the predetermined rule or may be configured to allocate a space by using the learning model.

### Generation Unit

The generation unit 12 generates a storage available period during which the storage object can be stored in the space, based on current and future usage statuses of the space in which the storage object can be stored. The current and future usage statuses include information on a space determined to be used by another customer and information on a space expected to be used by another customer. “Expected” means that a space is planned to be used, but the use of the space has not been determined.

For example, it is assumed that A company wants to deposit a storage object in a space D from October to December. Then, it is assumed that B company has already planned (determined) to use the space D for a storage object from October to November. In addition, it is assumed that C company plans (expects) to use the space D for a storage object from November to December. In this case, the generation unit 12 generates “from November to December” as an available period for the space D of A company.

In a case where the period determined to be used by B company and the desired period of A company overlap with each other as described above, the generation unit 12 excludes the overlapped period from the available period. In addition, even if the expected usage of the space by C company and the desired period of A company overlap with each other, the generation unit 12 generates the available period including the overlapped period.

In the above-described example, the generation unit 12 may generate the available period of A company as “there is no available period”. That is, in the case where the period determined to be used by B company and the desired period of A company overlap with each other, the generation unit 12 excludes the overlapped period from the available period. In addition, also in a case where the expected usage of the space by C company and the desired period of A company overlap with each other, the generation unit 12 excludes the overlapped period from the available period.

The generation unit 12 generates the storage available period based on the current and future usage statuses of the space in which the storage object can be stored, by using a predetermined rule. The generation unit 12 may generate the storage available period by using a learning model. The learning model is a model obtained by learning of outputting the storage available period with the current and future usage statuses of the space in which the storage object can be stored as an input. For example, the learning model is a model obtained by learning of generation results in the past. That is, the generation unit 12 may be configured to generate the storage available period by using the predetermined rule or may be configured to generate the storage available period by using the learning model.

As described above, the storage management system 10 according to the present disclosure allocates the space in which the storage object can be stored from within the storage place, and generates the storage available period during which the storage object can be stored in the space, based on the current and future usage statuses of the space.

As a result, a management user of the storage place can accurately grasp in which space and during which period the storage object can be stored. Then, it is possible to smoothly conduct a business negotiation with a customer, for example, a business negotiation in which the customer desires to use a space. In the storage management system 10 according to the present disclosure, the storage place can therefore be effectively used.

### Distributed Processing

Pieces of processing by functional blocks of the allocation unit 11 and the generation unit 12 illustrated in FIG. 1 are not limited to being executed in a single device or a single server. A configuration may be adopted in which the pieces of processing may be processed in a distributed manner by a server and a device. This similarly applies to a storage management system to be described later.

### Storage Management Method

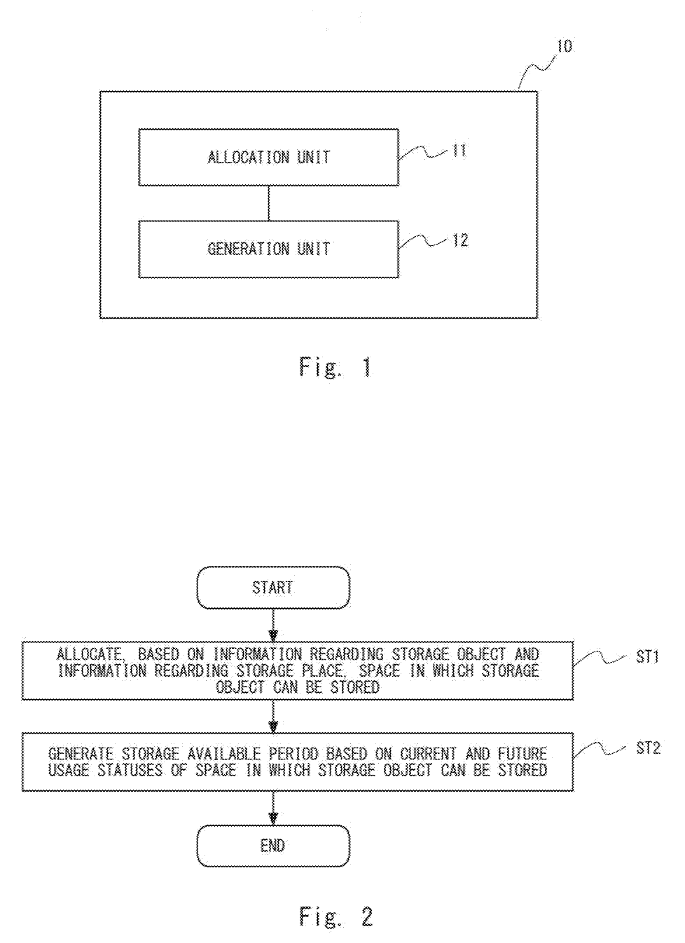

Next, a storage management method according to the present disclosure will be described. FIG. 2 is a flowchart illustrating the storage management method according to the present disclosure. Subjects of steps are the allocation unit 11 and the generation unit 12 illustrated in FIG. 1.

First, the allocation unit 11 allocates, based on information regarding a storage object desired to be stored and information regarding a storage place, a space in which the storage object can be stored from within the storage place (step ST1).

Next, the generation unit 12 generates a storage available period during which the storage object can be stored in the space, based on current and future usage statuses of the space in which the storage object can be stored (step ST2).

With such a configuration, in the storage management method according to the present disclosure, the management user of the storage place can accurately grasp in which space and during which period the storage object can be stored. Then, it is possible to smoothly conduct a business negotiation with a customer, for example, a business negotiation in which the customer desires to use a space. In the storage management method according to the present disclosure, the storage place can therefore be effectively used.

### Second Example Embodiment

### Storage Management System

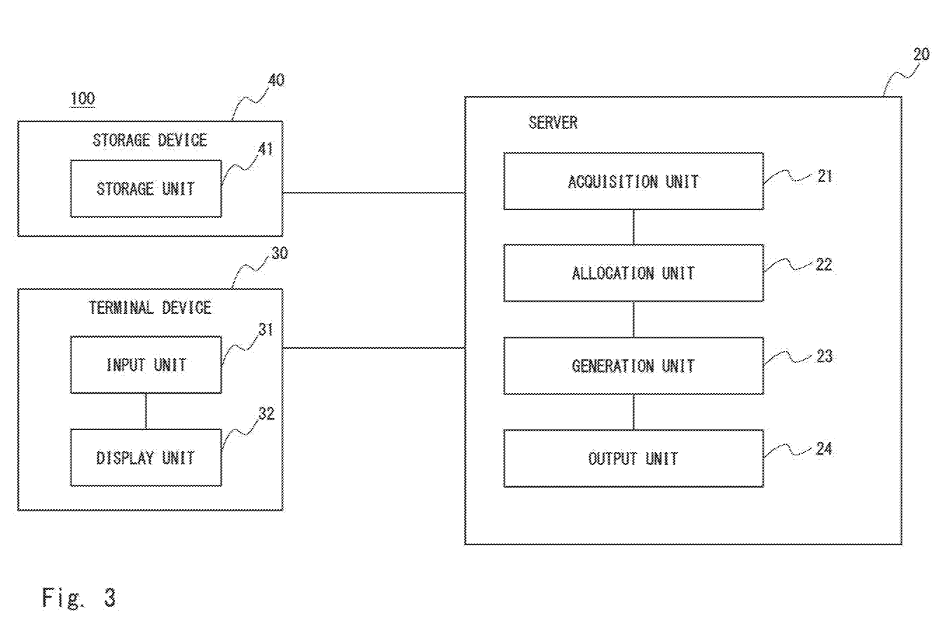

Hereinafter, a configuration of a storage management system according to the present disclosure will be described with reference to FIG. 3. FIG. 3 is a block diagram illustrating the storage management system according to the present disclosure. As illustrated in FIG. 3, a storage management system 100 includes a server 20, a terminal device 30, and a storage device 40. Hereinafter, a description will be given using a warehouse as an example of the storage place.

### Terminal Device

The terminal device 30 includes an input unit 31 and a display unit 32. The input unit 31 receives information regarding a storage object desired to be stored. The display unit 32 displays an output result by an output unit 24 of the server 20. The display unit 32 is typically a display.

The terminal device 30 is, for example, a terminal device used by a management user on the warehouse side. For example, the management user on the warehouse side inputs the information regarding the storage object desired to be stored to the input unit 31 by conducting a business negotiation with the customer. As a result, the input unit 31 receives the information regarding the storage object desired to be stored. The input unit 31 transmits the information regarding the storage object desired to be stored to an acquisition unit 21 of the server 20.

Note that the management user on the warehouse side is typically a sales representative, but is not limited thereto, and may be a field staff of the warehouse, a center manager, or management. Each of a plurality of management users on the warehouse side holds the terminal device 30, and each of the management users on the warehouse side can confirm the same display result from one’s own terminal device 30.

### Storage Device

The storage device 40 includes a storage unit 41. The storage unit 41 stores the information regarding the storage place. The storage unit 41 may store CAD data and design drawings in association with the information regarding the storage place. The storage device 40 transmits the information regarding the storage place to the acquisition unit 21 of the server 20.

### Server

The server 20 includes the acquisition unit 21, an allocation unit 22, a generation unit 23, and the output unit 24. Since the allocation unit 22 and the generation unit 23 are similar to the allocation unit 11 and the generation unit 12 illustrated in FIG. 1, the description thereof will be omitted. The server 20 is, for example, a cloud server or a physical server.

The acquisition unit 21 acquires the information regarding the storage object desired to be stored from the terminal device 30. In addition, the acquisition unit 21 acquires the information regarding the storage place from the storage device 40.

The output unit 24 outputs the space and the storage available period to the display unit 32 of the terminal device 30 so that the space and the storage available period can be displayed in a predetermined format. The predetermined format is, for example, a display format in which the space and the storage available period are superimposed on a plan view of the storage place, a display format in which the space and the storage available period are superimposed on a three-dimensional view of the storage place, and a display format in which the space and the storage available period are superimposed on a storage schedule. The predetermined format can be arbitrarily selected by the management user on the warehouse side.

In a case where there is no place in which storage is possible or period during which storage is possible, the output unit 24 outputs information for warning the management user of the storage place to the display unit 32 of the terminal device 30. The terminal device 30 may be configured to highlight the information for warning the management user, for example, by displaying the information in a color different from other displays.

### Display in Plane Format

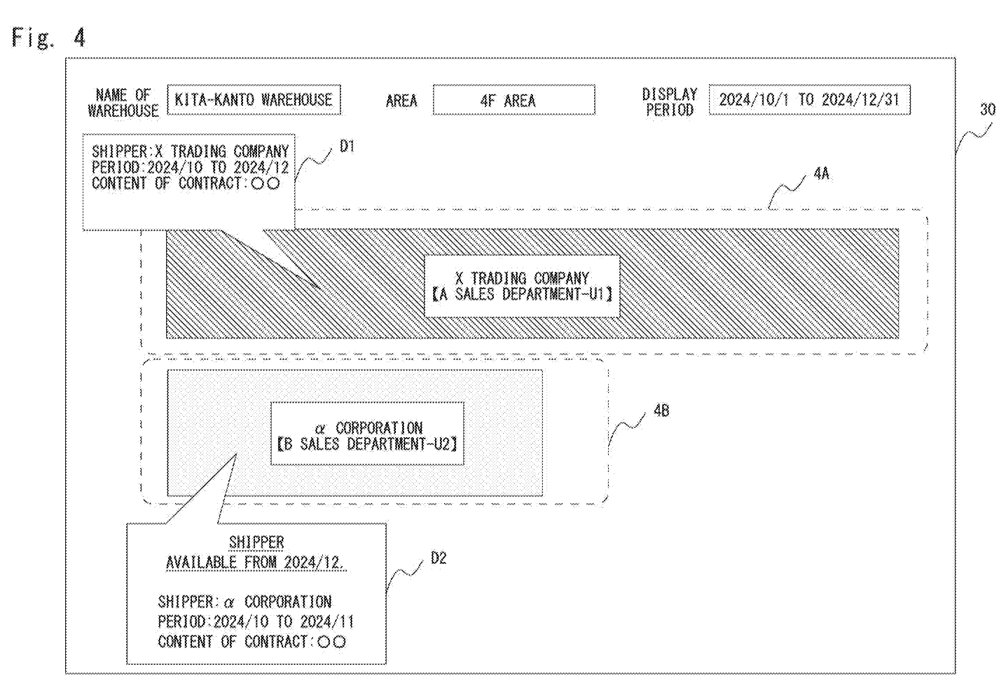

FIG. 4 is a display example of the terminal device 30. FIG. 4 illustrates the current and future usage statuses of the plan view of the fourth floor. In FIG. 4, information regarding customers, X trading company and α corporation, who are determined to use a storage warehouse is displayed on the terminal device 30. In FIG. 4, it is assumed that a customer (shipper) is a business negotiation partner who desires to use a storage place.

As illustrated in a display D1 of FIG. 4, an area 4A is used by X trading company from October to December 2024. In the terminal device 30, as illustrated in the display D1 of FIG. 4, content of a contract is displayed together as information regarding X trading company. In the display D1 of FIG. 4, a user name (A sales department-U1) on the warehouse side in charge of X trading company is also displayed.

As illustrated in a display D2 of FIG. 4, an area 4B is used by α corporation from October to November 2024. The content displayed for α corporation is similar to that for X trading company. As described above, in the example illustrated in FIG. 4, the current and future usage statuses of each customer (shipper) are illustrated.

As illustrated in the display D2 of FIG. 4, the terminal device 30 displays that a customer (shipper) can use the area 4B after December 2024. As described above, in the storage management system 100, the space in which storage is possible (area 4B) and the storage available period (after December 2024) can be superimposed and displayed on the plan view of the storage place (4F area).

Note that a configuration may be adopted in which the display D1 and the display D2 illustrated in FIG. 4 are always displayed on the terminal device 30, or a configuration may be adopted in which the displays are displayed in a pop-up manner if a user on the warehouse side performs touch operation (or puts a cursor) on the area 4A or the area 4B on the terminal device 30.

Here, conventionally, on the warehouse side, if there are requests for storage objects from customers, the requests from the customers are reported from respective sales representatives to the center manager, and the center manager performs adjustment of schedules and spaces in cooperation with the sales representatives and the field staff. As described above, conventionally, since the adjustment is performed by an analog method, it takes time to perform the adjustment.

However, in the storage management system 100, each management user on the warehouse side can confirm the display result of FIG. 4 from one’s own terminal device 30. As a result, it is possible to smoothly perform adjustment between the management users on the warehouse side.

As illustrated in FIG. 4, in the terminal device 30, with each area, information of a customer who uses the area and information of a person in charge are associated. The user on the warehouse side can therefore easily grasp a vacancy by viewing the display result by the terminal device 30. As a result, in the storage management system 100, it is possible to suppress usage of the same space by different customers during the same period, in other words, it is possible to suppress overlapping of usage by customers.

Further, since the management user on the warehouse side can confirm the display result of FIG. 4 from the terminal device 30, it is possible to suppress storage of the storage object in a wrong place and erroneous shipment. The management user on the warehouse side can devise a method for improving storage efficiency by using the display result of FIG. 4 from the terminal device 30.

### Display in Schedule Format

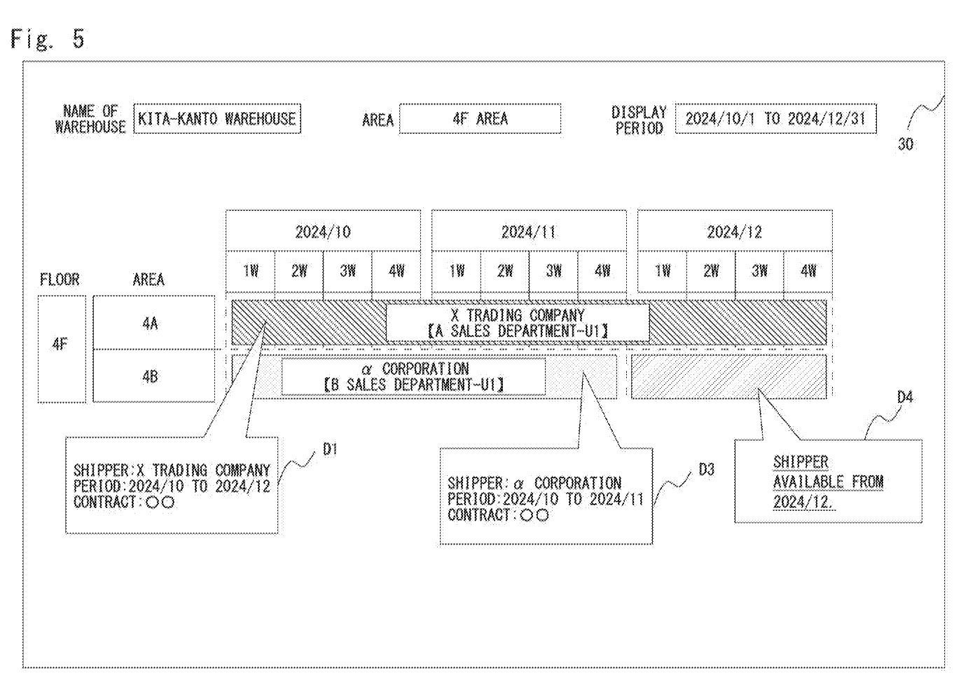

FIG. 5 is a display example of the terminal device 30. FIG. 5 illustrates the current and future usage statuses of the fourth floor. As illustrated in FIG. 5, in the terminal device 30, information corresponding to FIG. 4 is displayed in a schedule format.

That is, as illustrated in the display D1 of FIG. 5, the area 4A is used by X trading company from October to December 2024. As illustrated in a display D3 of FIG. 5, the area 4B is used by α corporation from October to November 2024. As illustrated in a display D4 of FIG. 5, the terminal device 30 displays that a customer (shipper) can use the area 4B after December 2024.

As described above, in the storage management system 100, the space in which storage is possible (area 4B) and the storage available period (after December 2024) can be superimposed and displayed on the plan view of the storage place (4F area).

As described above, the output unit 24 outputs the space and the storage available period to the display unit 32 of the terminal device 30 so that the space and the storage available period can be displayed in a predetermined format. As a result, the management user of the storage place can accurately grasp in which space and during which period the storage object can be stored. Then, it is possible to smoothly conduct a business negotiation with a customer, for example, a business negotiation in which the customer desires to use a space. In the storage management system 100 according to the present disclosure, the storage place can therefore be effectively used.

The management user of the storage place can grasp a future usage status, for example, “X trading company has a determined plan to use the area 4A from October to December (see FIG. 5)”, according to the display result by the terminal device 30. The management user of the storage place can therefore devise a storage plan, for example, preparation for receiving the storage object, cleaning of the corresponding space, and arrangement of people, before receiving the storage object.

Note that a configuration may be adopted in which the management user of the storage place inputs an area on the terminal device 30, whereby the terminal device 30 performs display with the input area as a target. Similarly, a configuration may be adopted in which the management user of the storage place inputs the information regarding the storage object, whereby the terminal device 30 displays an area where the storage object is stored. As described above, the terminal device 30 can perform condition search and display a search result thereof.

### Overlap with Expectation

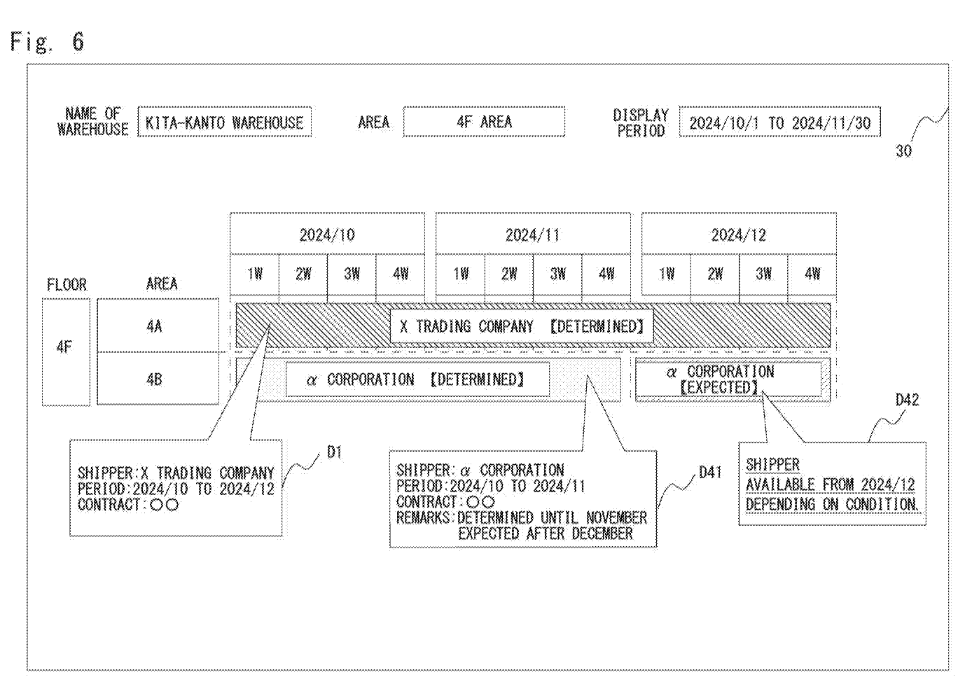

Here, in FIGS. 4 and 5, information regarding a customer who is determined to use the storage warehouse is displayed on the terminal device 30. What is displayed on the terminal device 30 is not limited to the information regarding the determined customer, and may be information regarding a customer who is expected to use the storage warehouse. A specific description will be given with reference to FIG. 6. FIG. 6 is a display example of the terminal device 30. FIG. 6 illustrates the current and future usage statuses of the fourth floor.

As illustrated in the display D1 of FIG. 6, the area 4A is determined to be used by X trading company from October to December 2024. As illustrated in a display D41 of FIG. 6, the area 4B is determined to be used by α corporation from October to November 2024.

Here, the area 4B is expected to be used by α corporation in December 2024. In this case, as illustrated in a display D42 of FIG. 6, the terminal device 30 displays that a customer (shipper) can use the area 4B with a condition after December 2024.

As described above, in the storage management system 100, a period for a space expected to be used by another customer (shipper) may be displayed by being included in an available period of a customer (shipper) who is a requester. With the display result, the management user of the storage place negotiates with another customer who is expected to use the storage place and the customer who is the requester. As a result, either one can use the space. Each may use half of the space by negotiation. Even in a case where another customer who is expected to use the storage place cancels the storage place, the storage place can be effectively used since the customer who is the requester can use the storage place. As described above, in the storage management system 100, the storage place can be effectively used.

### Display Method

In the examples illustrated in FIGS. 4 and 5, the terminal device 30 performs display by changing hatching for each customer. However, not limited thereto, the terminal device 30 only needs to be configured to perform display in a distinguishable manner for each customer. For example, the terminal device 30 performs display distinguishably by color-coding for each customer.

In the example illustrated in FIG. 6, the terminal device 30 displays determined information and expected information on α corporation by changing hatching so that the pieces of information can be distinguished from each other. As described above, the terminal device 30 may display the determined information and the expected information in a distinguishable manner.

The terminal device 30 may display content of business negotiation and a progress status of the business negotiation in association with the expected information, and perform grading according to the content of the business negotiation and the progress status of the business negotiation. Then, in the terminal device 30, pieces of expected information may be displayed in a distinguishable manner for respective grades.

Processing regarding the above-described display method is executed in the terminal device 30, for example. The output unit 24 of the server 20 may execute the processing regarding the display method and transmit information after the processing to the terminal device 30.

### Masking

Here, in a case where only a predetermined user is detected, the output unit 24 may further output a space determined to be used for storage and a space expected to be used for storage, and information regarding current and future usage statuses of the spaces so that they are displayed in a visible state. The predetermined user is, for example, the management user of the storage place.

In a case where a user other than the predetermined user is detected, the output unit 24 may output a space determined to be used for storage and a space expected to be used for storage, and information regarding current and future usage statuses of the spaces so that they are displayed in a masked state.

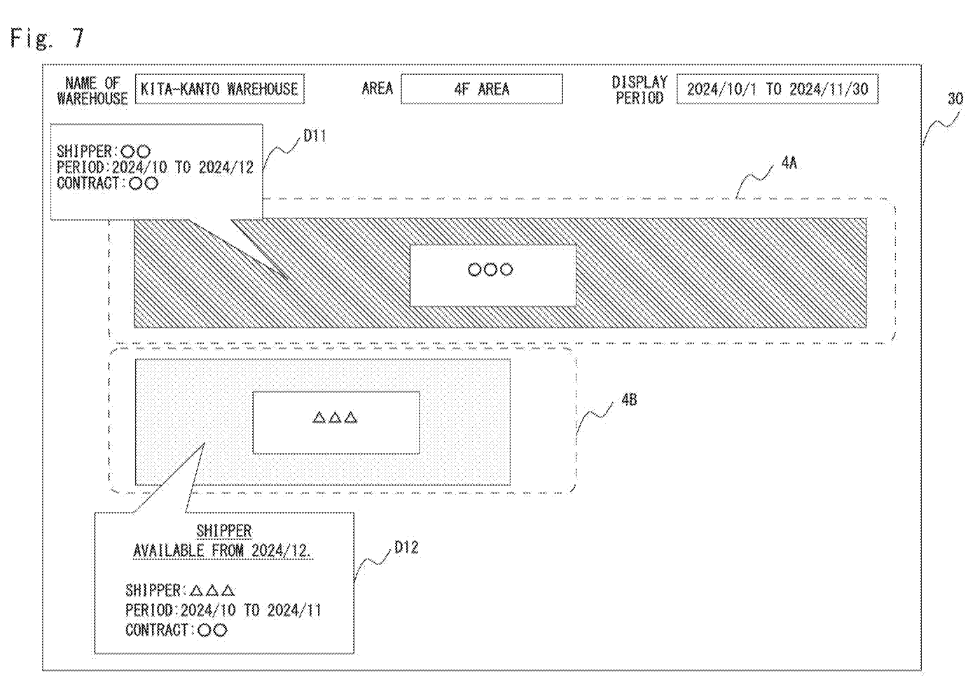

A specific description will be given with reference to FIGS. 4 and 7. FIG. 7 is a display example of the terminal device 30. FIG. 7 illustrates the current and future usage statuses of the plan view of the fourth floor. In a case where only the management user of the storage place is detected, the output unit 24 outputs the information illustrated in FIG. 4, and the terminal device 30 displays the information as illustrated in FIG. 4.

On the other hand, it is assumed that the output unit 24 detects a user other than the management user of the storage place. Then, the output unit 24 outputs the information illustrated in FIG. 7, and the terminal device 30 displays the information as illustrated in FIG. 7.

Specifically, as illustrated in a display D11 and a display D12 of FIG. 7, in the terminal device 30, only information regarding periods in which usage of the areas 4A and 4B is determined is displayed.

That is, in FIG. 4, it can be grasped that the user of the area 4A is X trading company, and the user of the area 4B is α corporation. On the other hand, in FIG. 7, these pieces of information are masked and cannot be grasped.

As described above, the output unit 24 can mask information regarding a customer other than the requester depending on whether the management user of the storage place has been detected. For example, in a case where the management user of the storage place holds a hearing of the customer’s request (business negotiation) while looking at and operating one’s own terminal device, masking of information on another customer is unnecessary as illustrated in FIG. 4.

On the other hand, for example, in a case where the management user of the storage place and the customer hold a hearing of the customer's request (business negotiation) while sharing the display of the terminal device, it is preferable to mask information on another customer as illustrated in FIG. 7. As described above, in the storage management system 100, information management of customers can be reliably performed.

### Third Example Embodiment

### Storage Management System

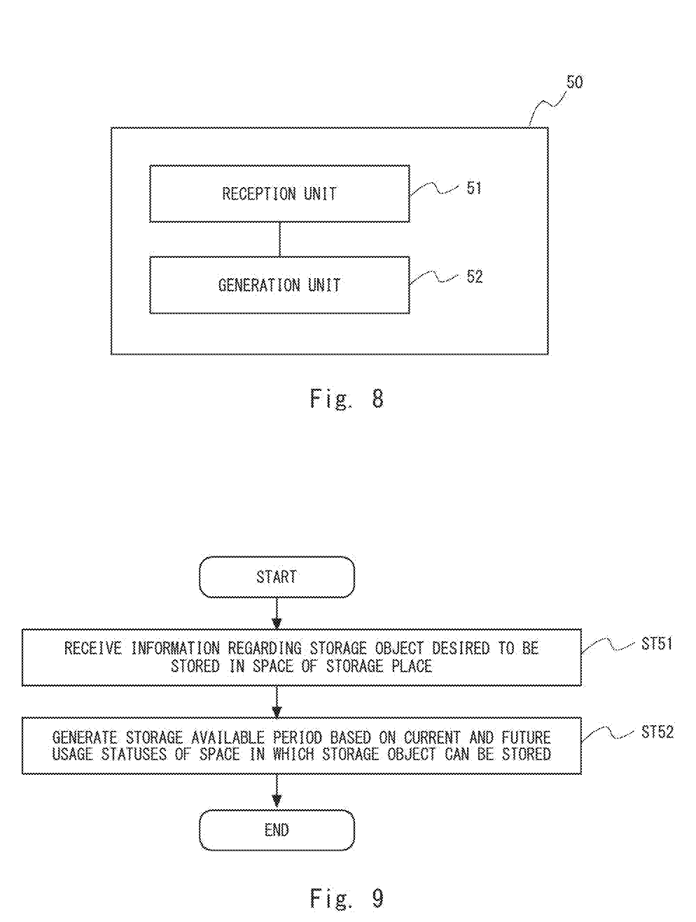

Hereinafter, a configuration of a storage management system according to the present disclosure will be described with reference to FIG. 8. FIG. 8 is a block diagram illustrating the storage management system according to the present disclosure. As illustrated in FIG. 8, a storage management system 50 includes a reception unit 51 and a generation unit 52. Since the generation unit 52 is similar to the generation unit 12 illustrated in FIG. 1, the description thereof will be omitted.

The reception unit 51 illustrated in FIG. 8 receives information regarding a storage object desired to be stored in a space of a storage place. For example, the management user on the warehouse side inputs information regarding a storage object desired to be stored in a space requested by a customer by dragging. As a result, the reception unit 51 receives the information regarding the storage object for the space requested by the customer.

As another example, the management user on the warehouse side inputs the information regarding the storage object desired to be stored in the space requested by the customer by voice. Specifically, the management user on the warehouse side utters “preserve fish in an area B”. As a result, the reception unit 51 receives information regarding fish for the area B.

Note that the reception unit 51 may determine that it is necessary to perform frozen storage from information such as “fish” of the utterance of the management user on the warehouse side, and may include a storage characteristic such as the frozen storage in the information regarding the fish and receive the information. That is, the reception unit 51 may receive, from the input information by the management user on the warehouse side, the information regarding the storage object, for example, information regarding the name, packing style, size, amount, weight, storage characteristics, customer (shipper), and storage period of the storage object.

As described above, the storage management system 50 according to the present disclosure receives the information regarding the storage object for the space of the storage place, and generates the storage available period during which the storage object can be stored in the space. As a result, the management user of the storage place can accurately grasp during which period the storage object can be stored in the space requested by the customer. Then, in the storage management system 50 according to the present disclosure, it is possible to smoothly conduct a business negotiation with the customer, for example, a business negotiation in which the customer desires to use a space. In the storage management system 50 according to the present disclosure, the storage place can therefore be effectively used.

### Storage Management Method

Next, a storage management method according to the present disclosure will be described. FIG. 9 is a flowchart illustrating an information processing method according to the present disclosure. Subjects of steps are the reception unit 51 and the generation unit 52 illustrated in FIG. 8.

First, the reception unit 51 receives information regarding a storage object desired to be stored in a space of a storage place (step ST51). Next, the generation unit 52 generates a storage available period during which the storage object can be stored in the space, based on current and future usage statuses of the space in which the storage object can be stored (step ST52).

As described above, the storage management method according to the present disclosure receives the information regarding the storage object for the space of the storage place, and generates the storage available period during which the storage object can be stored in the space. As a result, in the storage management method according to the present disclosure, the management user of the storage place can accurately grasp during which period the storage object can be stored in the space requested by the customer. Then, in the storage management method according to the present disclosure, it is possible to smoothly conduct a business negotiation with the customer, for example, a business negotiation in which the customer desires to use a space. In the storage management method according to the present disclosure, the storage place can therefore be effectively used.

### Fourth Example Embodiment

### Storage Management System

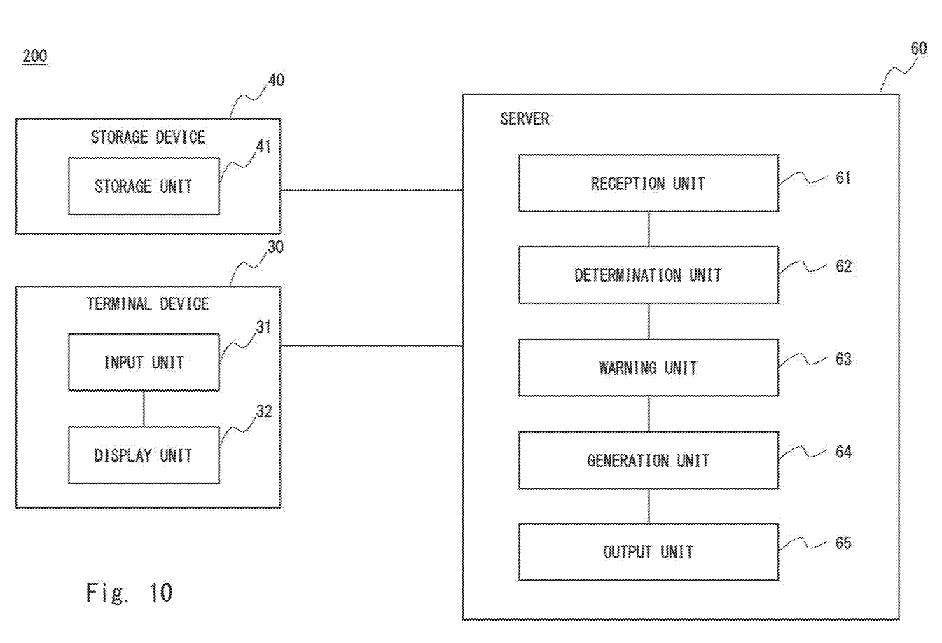

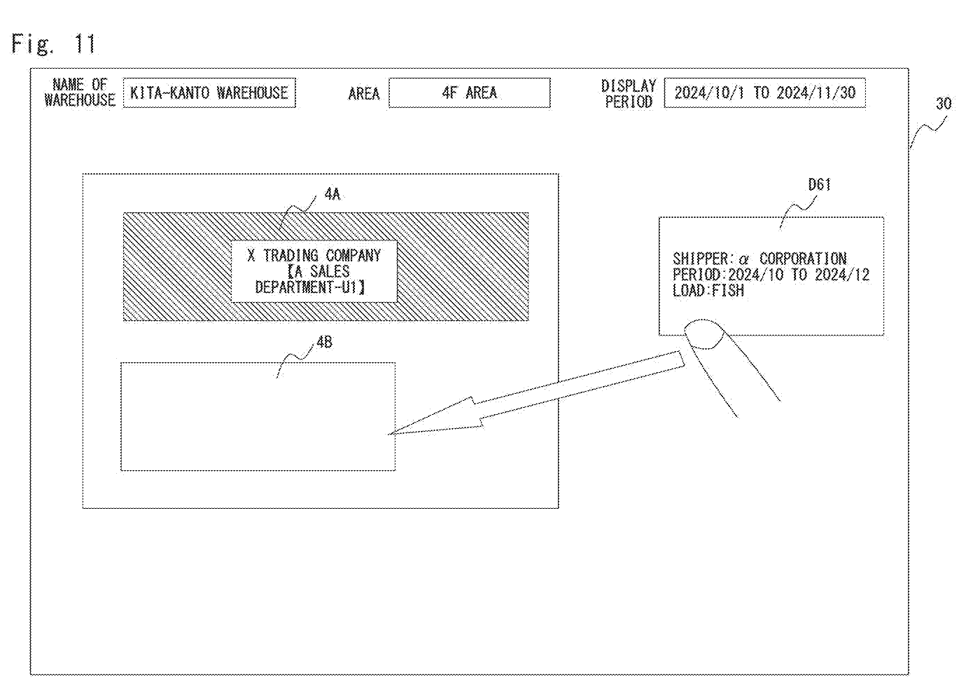

Hereinafter, a configuration of a storage management system according to the present disclosure will be described with reference to FIG. 10. FIG. 10 is a block diagram illustrating the storage management system according to the present disclosure. As illustrated in FIG. 10, a storage management system 200 includes a server 60, the terminal device 30, and the storage device 40. Since the terminal device 30 and the storage device 40 are similar to those in FIG. 3, the description thereof will be omitted.

### Server

The server 60 includes a reception unit 61, a determination unit 62, a warning unit 63, a generation unit 64, and an output unit 65. Since the generation unit 64 and the output unit 65 have configurations similar to those of the generation unit 23 and the output unit 24 illustrated in FIG. 3, the description thereof will be omitted.

The reception unit 61 has a configuration similar to that of the reception unit 51 illustrated in FIG. 8. Here, it is assumed that the reception unit 61 receives information regarding a storage object after the information regarding the storage object is input by dragging. The server 60 is, for example, a cloud server or a physical server. Hereinafter, the determination unit 62 and the warning unit 63 will be described.

In response to the reception of the information regarding the storage object, the determination unit 62 determines whether the storage object can be stored in a space, based on the information regarding the storage object and information on the space. The information regarding the storage object includes information of the name, packing style, size, amount, weight, storage characteristics, customer (shipper), and storage period of the storage object. The information on the space includes information regarding the area, volume, temperature, humidity, hygienic status, atmospheric pressure, explosion-proof specification, and fire resistance.

The determination by the determination unit 62 is not limited to determining whether the storage object can be stored in the space of the storage place for which the information regarding the storage object desired to be stored is received. The determination unit 62 may determine whether the storage object can be stored in a surrounding space including an adjacent space and a vicinity space of the storage place.

The warning unit 63 generates warning information indicating information for warning the user in a case where the storage object cannot be stored in the space. The output unit 65 outputs the warning information to the terminal device 30. The warning unit 63 does not generate warning information in a case where the storage object can be stored in the space.

### Example of Input by Dragging

Next, an example of input by dragging will be described with reference to FIGS. 11 to 13. FIGS. 11 to 13 are display examples of the terminal device 30. In FIGS. 11 to 13, a plan view of the fourth floor is displayed on the left side of the terminal device 30. In FIGS. 11 to 13, it is assumed that the area A is determined to be used by X trading company. It is assumed that the area 4B is vacant.

As illustrated in FIG. 11, the management user on the warehouse side inputs a display D61 to the area 4B by dragging. The display D61 is a display of information regarding a storage object of α corporation (customer). The area 4B is a desired space of α corporation. As a result, the reception unit 61 receives the information (display D61) regarding the storage object of α corporation (customer) for the area 4B. Then, the determination unit 62 determines whether the storage object can be stored in the space, based on the display D61 and the area 4B.

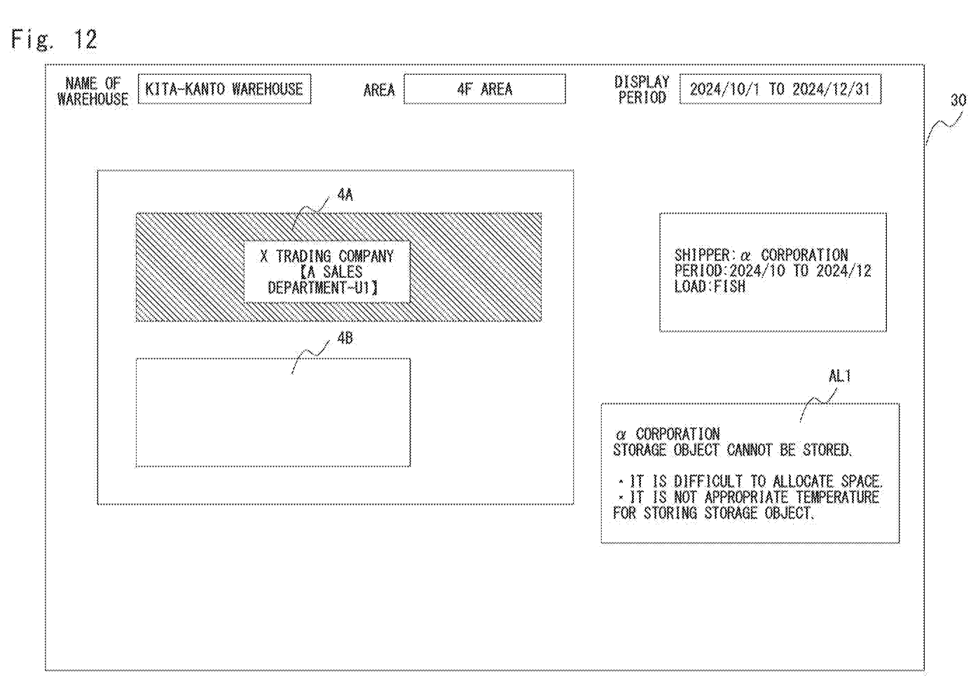

A case where warning is issued will be described with reference to FIG. 12. In a case where the storage object of α corporation cannot be stored in the area 4B, warning information AL1 is displayed on the terminal device 30 as illustrated in FIG. 12.

The warning information AL1 includes the fact that the storage object of α corporation cannot be stored and the reason why the storage object cannot be stored. As described above, the storage management system 200 displays warning in a case where the storage object of the customer cannot be stored in the space desired by α corporation (customer).

With the warning, it is possible to hold a hearing of the request of α corporation (customer) again and smoothly conduct the business negotiation. In the storage management system 200 according to the present disclosure, the storage place can therefore be effectively used. Note that the terminal device 30 may be configured to highlight the warning information AL1, for example, display the warning information AL1 in a changed color.

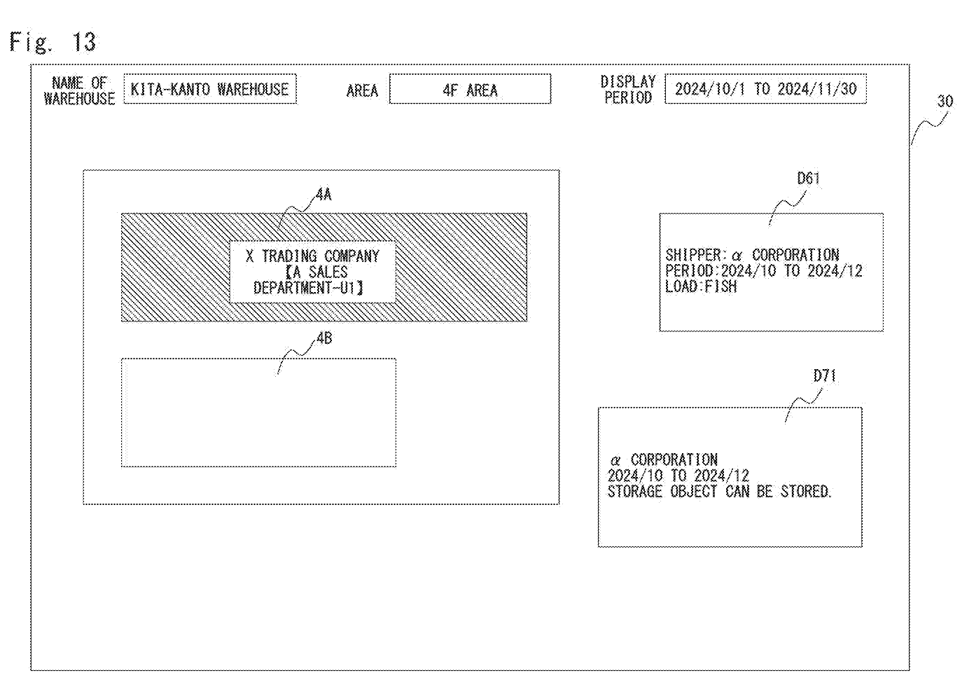

A case where no warning is issued will be described with reference to FIG. 13. In a case where the storage object of α corporation can be stored in the area 4B, as illustrated in FIG. 13, warning information is not displayed on the terminal device 30, and a display D71 indicating that the storage object can be stored is displayed.

With the display D71, the management user of the storage place can accurately grasp during which period the storage object can be stored in the space requested by α corporation (customer). In the storage management method according to the present disclosure, the storage place can therefore be effectively used.

In the example illustrated in FIGS. 11 to 13, an example has been described in which the determination unit 62 determines whether the storage object of α corporation can be stored in the area 4B, based on the information (display D61) regarding the storage object of α corporation and the desired space (area 4B) of α corporation. However, not limited thereto, the determination unit 62 may determine whether the storage object of α corporation can be stored even in a space around the desired space (area 4B) of α corporation.

### Fifth Example Embodiment

### Server

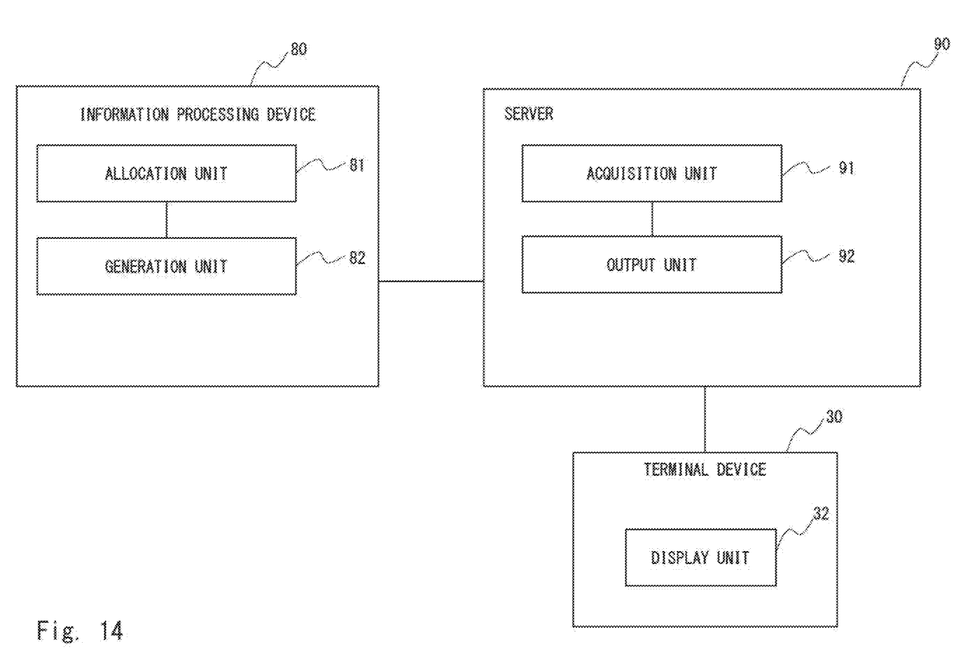

Hereinafter, a configuration of a server according to the present disclosure will be described with reference to FIG. 14. FIG. 14 is a block diagram illustrating the server according to the present disclosure. As illustrated in FIG. 14, a server 90 is connected to an information processing device 80 via wired or wireless communication. The server 90 is connected to the terminal device 30 via wired or wireless communication.

The information processing device 80 includes an allocation unit 81 and a generation unit 82. Since pieces of processing by the information processing device 80 are similar to the pieces of processing by the allocation unit 11 and the generation unit 12 illustrated in FIG. 1, the description thereof will be omitted. The terminal device 30 includes the display unit 32. Since the terminal device 30 has a configuration similar to that in FIG. 3, the description thereof will be omitted.

The server 90 includes an acquisition unit 91 and an output unit 92. The acquisition unit 91 acquires information regarding a space in which a storage object desired to be stored by a customer (shipper) can be stored. The information regarding the space in which the storage object can be stored is information regarding a space allocated from within a storage place, based on information regarding the storage object and information regarding the storage place. That is, the acquisition unit 91 acquires the information regarding the space in which the storage object can be stored from the allocation unit 81 of the information processing device 80.

The acquisition unit 91 acquires information regarding a storage available period during which the storage object can be stored in the space. The information regarding the storage available period during which the storage object can be stored in the space is information regarding a storage available period generated based on current and future usage statuses of the space. That is, the acquisition unit 91 acquires, from the generation unit 82 of the information processing device 80, the information regarding the storage available period during which the storage object can be stored in the space.

The output unit 92 outputs, to the display unit 32 of the terminal device 30, the information regarding the space in which the storage object can be stored and the information regarding the storage available period during which the storage object can be stored in the space.

In other words, the server 90 acquires a processing result by the information processing device 80 and outputs the processing result to the display unit 32 of the terminal device 30. As described above, the server 90 serves as a relay device between the information processing device 80 and the terminal device 30.

The management user of the storage place can accurately grasp in which space and during which period the storage object can be stored according to the display result by the terminal device 30. Then, it is possible to smoothly conduct a business negotiation with the customer, for example, a business negotiation in which the customer desires to use a space. In the server 90 according to the present disclosure, the storage place can therefore be effectively used.

### Information Processing Method

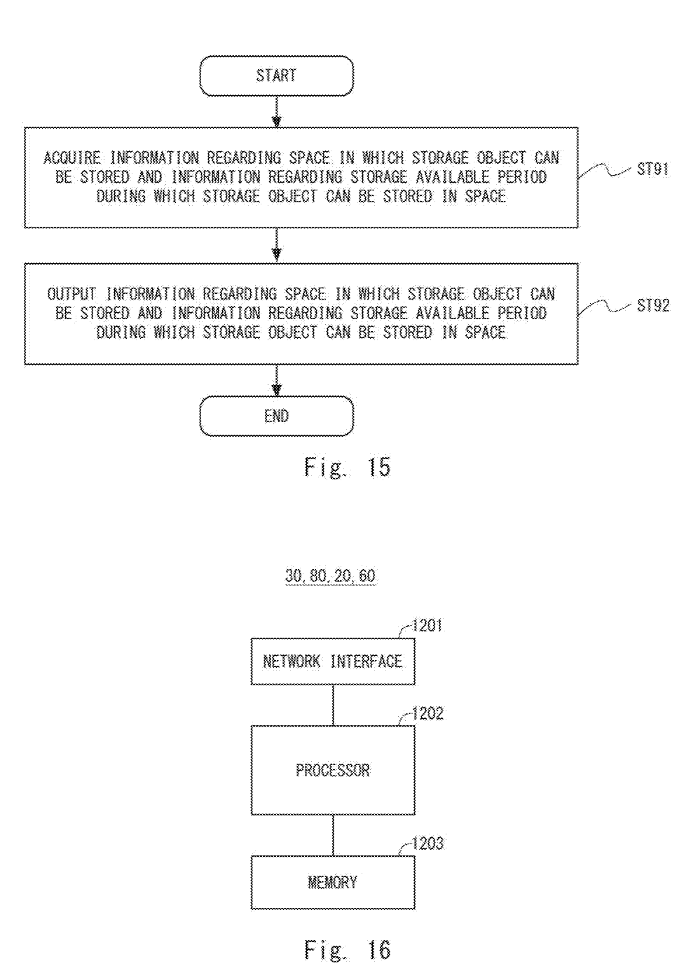

Next, an information processing method according to the present disclosure will be described. FIG. 15 is a flowchart illustrating an information processing method according to the present disclosure. Subjects of steps are the acquisition unit 91 and the output unit 92 illustrated in FIG. 14.

As illustrated in FIG. 15, the acquisition unit 91 of the server 90 acquires, from the information processing device 80, the information regarding the space in which the storage object can be stored and the information regarding the storage available period during which the storage object can be stored in the space (step ST91).

As illustrated in FIG. 15, the output unit 92 of the server 90 outputs, to the terminal device 30, the information regarding the space in which the storage object can be stored and the information regarding the storage available period during which the storage object can be stored in the space (step ST92).

With such a configuration, the management user of the storage place can accurately grasp in which space and during which period the storage object can be stored from the display result by the terminal device 30. Then, it is possible to smoothly conduct a business negotiation with the customer, for example, a business negotiation in which the customer desires to use a space. In the information processing method according to the present disclosure, the storage place can therefore be effectively used.

### Configuration Example

FIG. 16 is a block diagram illustrating a configuration example of the terminal device, the information processing device, and the server according to the present disclosure. FIG. 16 is a block diagram illustrating a configuration example of the above-described terminal device 30, information processing device 80, and servers 20 and 60 (hereinafter, referred to as the terminal device 30 and the like). Referring to FIG. 16, the terminal device 30 and the like include a network interface 1201, a processor 1202, and a memory 1203. The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 reads and executes software (computer program) from the memory 1203 to perform processing by the terminal device 30 and the like described using the flowcharts in the above-described example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include storage arranged away from the processor 1202. In this case, the processor 1202 may access the memory 1203 via an Input/Output (I/O) interface (not illustrated).

In the example in FIG. 16, the memory 1203 is used to save software modules. The processor 1202 can perform the processing by the terminal device 30 and the like described in the above-described example embodiments by reading and executing these software modules from the memory 1203.

As described with reference to FIG. 16, each of the processors included in the terminal device 30 and the like executes one or a plurality of programs including instructions for causing a computer to perform an algorithm described with reference to the drawings.

In the above-described example, the program includes instructions (or software codes) for causing the computer to perform one or more functions described in the example embodiments, in the case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, magnetic disk storage, or any other magnetic storage device. The program may be transmitted through a transitory computer-readable medium or a communication medium. The program is included in the program product. As an example and not by way of limitation, the transitory computer-readable medium or the communication medium includes propagated signals in electrical, optical, acoustic, or any other form.

Although the present disclosure has been described in accordance with the above example embodiments, the present disclosure is not limited to the configurations of the above example embodiments, and includes various modifications, corrections, and combinations that can be made by those skilled in the art within the scope of the claims of the present application.

Each drawing is merely illustrative for describing one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any of the drawings may be changed as appropriate.

Some or all of the above example embodiments can also be described as the following supplementary notes, but are not limited to the following.

### Supplementary note 1

A storage management system including an allocation unit that allocates, based on information regarding a storage object desired to be stored and information regarding a storage place, a space in which the storage object is storable from within the storage place, and a generation unit that generates a storage available period during which the storage object is storable in the space, based on current and future usage statuses of the space.

### Supplementary note 2

The storage management system according to supplementary note 1, further including an output unit that outputs the space and the storage available period to be displayable in a predetermined format.

### Supplementary note 3

The storage management system according to supplementary note 1 or 2, in which the allocation unit allocates a storage place, based on information indicating a storage characteristic for securing a predetermined separation distance from another storage object in the information regarding the storage object.

### Supplementary note 4

The storage management system according to supplementary note 2, in which the output unit further outputs, in a case where only a predetermined user is detected, a space determined to be used for storage and information regarding current and future usage statuses of the space to be displayed in a visible state, and outputs, in a case where a user other than the predetermined user is detected, the space determined to be used for storage and the information regarding the current and future usage statuses of the space to be displayed in a masked state.

### Supplementary note 5

The storage management system according to supplementary note 4, in which the output unit further outputs, in a case where only a predetermined user is detected, a space expected to be used for storage and information regarding current and future usage statuses of the space to be displayed in a visible state, and outputs, in a case where a user other than the predetermined user is detected, the space expected to be used for storage and the information regarding the current and future usage statuses of the space to be displayed in a masked state.

### Supplementary note 6

A storage management system including a reception unit that receives information regarding a storage object desired to be stored in a space of a storage place, and a generation unit that generates a storage available period during which the storage object is storable in the space, based on current and future usage statuses of the space.

### Supplementary note 7

The storage management system according to supplementary note 6, in which the reception unit receives the information regarding the storage object after the information regarding the storage object is input by dragging.

### Supplementary note 8

The storage management system according to supplementary note 6 or 7, further including a determination unit that determines whether the storage object is storable in the space, based on the information regarding the storage object and information on the space, in response to reception of the information regarding the storage object; and a warning unit that generates information for warning a user in a case where the storage object is not storable in the space.

### Supplementary note 9

The storage management system according to supplementary note 8, in which the determination unit further determines whether the storage object is storable in the space, based on a predetermined storage characteristic for securing a predetermined separation distance from another storage object in the information regarding the storage object.

### Supplementary note 10

A server including an acquisition unit that acquires information regarding a space in which a storage object desired to be stored is storable, the information regarding the space allocated, based on information regarding the storage object and information regarding a storage place, from within the storage place, and information regarding a storage available period during which the storage object is storable in the space, the information regarding the storage available period generated based on current and future usage statuses of the space, and an output unit that outputs the information regarding the space and the information regarding the storage available period.

### Supplementary note 11

A storage management method including, executing, by a computer, processing of allocating, based on information regarding a storage object desired to be stored and information regarding a storage place, a space in which the storage object is storable from within the storage place, and generating a storage available period during which the storage object is storable in the space, based on current and future usage statuses of the space.

### Supplementary note 12

A non-transitory computer-readable medium storing a program for causing a computer to execute: allocating, based on information regarding a storage object desired to be stored and information regarding a storage place, a space in which the storage object is storable from within the storage place; and generating a storage available period during which the storage object is storable in the space, based on current and future usage statuses of the space.

Some or all of the elements (for example, configurations and functions) described in supplementary notes 2 to 5 dependent on supplementary note 1 can also be dependent on supplementary notes 10, 11, and 12 by a dependency relationship similar to those of supplementary notes 2 to 5. Some or all of the elements (for example, configurations and functions) described in supplementary notes 2, 4, and 5 dependent on supplementary note 1 can also be dependent on supplementary note 6 by a dependency relationship similar to those of supplementary notes 2, 4, and 5. Some or all of the elements described in any supplementary note may be applied to various types of hardware, software, recording means for recording software, systems, and methods.

1. A storage management system comprising:
at least one memory storing instructions; and
at least one processor configured to execute the instructions to:
allocate, based on information regarding a storage object desired to be stored and information regarding a storage place, a space in which the storage object is storable from within the storage place; and
generate a storage available period during which the storage object is storable in the space, based on current and future usage statuses of the space.

2. The storage management system according to claim 1, wherein the at least one processor is further configured to execute the instructions to output the space and the storage available period to be displayable in a predetermined format.

3. The storage management system according to claim 1, wherein the at least one processor is further configured to execute the instructions to allocate a storage place, based on information indicating a storage characteristic for securing a predetermined separation distance from another storage object in the information regarding the storage object.

4. The storage management system according to claim 2, wherein the at least one processor is further configured to execute the instructions to:
output, in a case where only a predetermined user is detected, a space determined to be used for storage and information regarding current and future usage statuses of the space to be displayed in a visible state, and
output, in a case where a user other than the predetermined user is detected, the space determined to be used for storage and the information regarding the current and future usage statuses of the space to be displayed in a masked state.

5. A storage management system comprising:
at least one memory storing instructions; and
at least one processor configured to execute the instructions to:
receive information regarding a storage object desired to be stored in a space of a storage place; and
generate a storage available period during which the storage object is storable in the space, based on current and future usage statuses of the space.

6. The storage management system according to claim 5, wherein the at least one processor is further configured to execute the instructions to receive the information regarding the storage object after the information regarding the storage object is input by dragging.

7. The storage management system according to claim 5, wherein the at least one processor is further configured to execute the instructions to:
determine whether the storage object is storable in the space, based on the information regarding the storage object and information on the space, in response to reception of the information regarding the storage object; and
generate information for warning a user in a case where the storage object is not storable in the space.

8. The storage management system according to claim 7, wherein the at least one processor is further configured to execute the instructions to determine whether the storage object is storable in the space, based on a predetermined storage characteristic for securing a predetermined separation distance from another storage object in the information regarding the storage object.

9. A storage management method causing a computer to execute:
allocating, based on information regarding a storage object desired to be stored and information regarding a storage place, a space in which the storage object is storable from within the storage place; and
generating a storage available period during which the storage object is storable in the space, based on current and future usage statuses of the space.
